(19) United States
(12) Patent Application Publication
(10) Pub. No.: US 2005/0131812 A1
(43) Pub. Date: Jun. 16, 2005

(54) Methods for transferring payment in EV payment and verifications systems

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 10/811,643

(22) Filed: Mar. 29, 2004

Related U.S. Application Data
(60) Provisional application No. 60/529,071, filed on Dec. 11, 2003.

(51) Int. Cl. G06F 17/60

(52) U.S. Cl. 705/39; 705/38; 705/40

(57) ABSTRACT

The invention is a method for operating an online computer database system for transacting EV payment offers. The system enables a payer to enter a payment offer that specifies the amount of EV payment to be paid to a qualified recipient(s). The system enables a recipient to accept the offer. The inventive method splits the EV payment process into two-bet “parlay” process such that the EV of the first bet equals the EV payment set by the payer, and the EV of the second bet equals the payoff from the first bet. In this parlay process, the payer takes the risk of losing the payoff in the first bet, and the system takes the risk of losing the payoff in the second bet. If the recipient wins the first bet, the system registers that the payer owes the payoff of this first bet to the system. The system then asks the recipient whether he meets the conditions of the payment offer. If the response is negative, the system refunds the payoff to the payer. If the response is positive, the system executes the second bet. If the recipient wins this second bet, the recipient provisionally has won the second bet payoff (larger than the first bet payoff). The recipient can request an inspection. If the inspection reveals that recipient has met the conditions of the offer, the system pays him the second bet payoff. If the recipient has not met the conditions, or if the recipient does not request an inspection, the system refunds the second bet payoff to the payer.

### CROSS-REFERENCES TO RELATED APPLICATIONS

This application refers to U.S. Pat. No. 5,269,521 describing the expected value payment method (EVPM).

This application refers to, and incorporates by reference, U.S. patent application Ser. Nos. 09/536,727 and 10/042,975 describing a method and system that use the EVPM for paying qualified audiences for attention.

This application refers to, and incorporates by reference, U.S. provisional patent application No. 60/529,071 describing a method and system that use the EVPM for paying targeted discounts to qualified buyers.

This application refers to U.S. patent application Ser. No. 10/424,190 describing a method and system that use the EVPM for paying qualified referrers a sales conmission.

### STATEMENT REGARDING FEDERALLY FUNDED RESEARCH

Not applicable.

### BACKGROUND

1. Field of the Invention

The invention relates to transferring payment using expected value (EV) payment.

2. Description of Related Art

U.S. Pat. No. 5,269,521 describes the EVPM.

Subsequent patent applications by the author used the EVPM in novel ways to solve important technical problems faced by businesses.

U.S. patent application Ser. Nos. 09/536,727 and 10/042,975 describe a method and system that use the EVPM for paying qualified audiences for their attention to messages.

U.S. provisional patent application 60/529,071 describes a method and system that use the EVPM for paying qualified buyers a discount.

U.S. patent application Ser. No. 10/424,190 describes a method and system that use the EVPM for paying qualified referrers a sales commission.

The basic methods described in this application here have already been disclosed in the above referenced applications.

The methods described in this application apply to situations in which a payment system enables a payer to pay a recipient an EV payment provided that the recipient meets specified conditions that are verified and/or tracked using the system.

This application elaborates on a method of using two EV payment bets to transfer a payment from a payer, through a system, to a recipient. In this method, the payer takes the payoff risk in the first bet while the system takes the payoff risk in the second bet.

In addition, this application describes a method for paying an EV amount that is based on a percentage of a purchase amount. This description is included here for the sake of completeness, but has already been disclosed in the above referenced applications.

In addition, this application describes how EV payments can be capped when EV payment is based upon a percentage of a purchase amount.

In addition, this application repeats descriptions in one or more of the above referenced applications of how transaction costs can be reduced with the use of deposits.

Other sub-methods are described that have been included in one or more of the above-referenced applications.

### OBJECT OF THE INVENTION

The object of the invention is to provide a method for enabling payment to be transferred from a payer, via the EV payment method, to a recipient who meets specified conditions, such that the payer does not have unaffordable payoff risk, and such that possible cheating by the payer is deterred.

### BRIEF SUMMARY OF THE INVENTION

The invention is a method for operating an online computer database system for transacting EV payment offers. The system enables a payer to enter a payment offer that specifies the amount of EV payment to be paid to a qualified recipient(s). The system enables a recipient to accept the offer.

The inventive method splits the EV payment process into two-bet “parlay” process such that the EV of the first bet equals the EV payment set by the payer, and the EV of the second bet equals the payoff from the first bet.

In this parlay process, the payer takes the risk of losing the payoff in the first bet, and the system takes the risk of losing the payoff in the second bet.

If the recipient wins the first bet, the system registers that the payer owes the payoff of this first bet to the system. The system then asks the recipient whether he meets the conditions of the payment offer.

If the response is negative, the system refunds the payoff to the payer. If the response is positive, the system executes the second bet.

If the recipient wins this second bet, the recipient provisionally has won the second bet payoff (larger than the first bet payoff). The recipient can request an inspection. If the inspection reveals that recipient has met the conditions of the offer, the system pays him the second bet payoff. If the recipient has not met the conditions, or if the recipient does not request an inspection, the system refunds the second bet payoff to the payer.

### BRIEF DESCRIPTION OF THE DRAWINGS

There are no drawings.

### DETAILED DESCRIPTION OF THE INVENTION

### Contents

Introduction:

How this Specification Is Written
Where the Inventive Methods Apply
Inspection (Verification) Process Reviewed
Example Scenario
Initial Definitions
   Part 1: Payer Takes All the Payoff Risk
   Part 2: System Takes All the Payoff Risk and Refunds Invalid Payoff claims to Payer
   Part 3: Two-Bet Process Where Payer and System Take Separate Payoff Risk, in which the First Bet Payoff Is Deducted from Payer
   Part 4: System Takes All the Payoff Risk and Uses a Discount Formula to Adjust for Invalid claims
   Part 5: Two-Bet Processes in Which EV Payment Equals a Percentage of a Sale
   Part 6: Using Deposits to Reduce Inspection Costs
   Part 7: Miscellaneous Sub-Methods for Efficient and User-Friendly Transactions

### Introduction

How this Specification is Written

This specification is organized as a set of descriptions of modules (sub-processes) that together comprise the inventive method. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

Many of the options described in this specification, such as certain terms of EV payment bets, may be held standard in practice. Those skilled in the art will readily see where a user option may be converted into a default.

We omit descriptions of the various methods that the inventive systems can include for charging users because these methods are well known and do not add to the disclosure.

Where the Inventive Methods Apply

The methods described in this application apply in payment systems operated according to a method that enables a payer to pay a recipient an EV payment, if the recipient meets specified conditions, which are probabilistically verified and/or tracked using the system.

We call this method the expected value methodfor paying and verifying (EVMPV). We call an online database system operated according to the EVMPV by the name expected value systemfor paying and verifying (EVSPV).

The EVMPV is a method for operating an online database system comprising the following elements and steps that are tailored in novel ways to solve specific problems:
1. A payer ID and bank account are established
2. A system account bank account exists
3. A payer posts a payment offer in the system
4. The offer is findable and selectable (acceptable) by recipient who can thus submit a claim for the payment offered
5. A recipient account, including a recipient ID, is registered
6. A recipient's claim submission is registered
7. An EV payment bet is executed to determine whether the claim submitted is worth a payoff multiple of its original value
8. If the claim is a winner, the submitter is informed that the claim is provisionally worth the payoff of the EV payment bet
9. If the submitter claims the payoff from the bet, a payoff claim is registered and a system-authorized inspector verifies whether the payment offer conditions were met
   a. Upon a negative determination entered by the inspector, the system registers that, the payoff claim is disqualified
   b. Upon a positive determination entered by the inspector, the system registers that the claim is worth the EV payment bet payoff.

Methods and systems employing variations of the method above were disclosed in patent applications filed by the author, including patent application Ser. Nos. 09/536,727 and 10/042,975 describing a method and system for paying qualified audiences for attention to sales messages; patent application Ser. No. 10/424,190 describing a method and system for paying commissions to referrers and; provisional application 60/529,071 describing a method and system for paying targeted discounts to qualified buyers.

All these applications are incorporated by reference.

The author plans to file additional applications disclosing methods and systems that use the EVMPV, including an additional application for paying referrers.

This application describes several methods for transferring payments from payers to recipients within an EVMPV and an EVSPV. This application does not concern itself with all the steps of an EVMPV, but with the payment transfer steps.

Note: In all cases below, if the EVSPV collects payment from payers, the EVSPV will include well-known debit and/or credit account processes. Further, the EVSPV will include well-known mechanisms for accepting payment and for notifying a payer and/or for suspending a payer's offer when her account has a low balance or an overdue balance.

Inspection (Verification) Process Reviewed

The EVMPV and EVSPV include steps for triggering a verification process, which we usually call an inspection process, and for registering the results of the inspection.

Let us briefly review an inspection process in the EVSPV so we can refer back to it.

When a user has submitted a payoff claim, the EVSPV (the system) will assign the claim data a status indicating that the claim data is to be examined by a system-authorized inspector. Thus, to enable an inspector to decide whether the user has met the offer conditions, the invention will provide a module for:
informing a system-authorized inspector that a claim is to be inspected,
enabling the inspector to inspect the claim data and,
enabling the inspector to view the corresponding payment offer.

The inspection will take place outside of the inventive system, and the inspector will enter the decision of the inspection into the system.

The system can enable an inspector to enter an inspection report explaining why he has rejected a claim, i.e., the system can include a standard menu of explanation options (like form-letter responses) that an inspector can select from to explain his claim rejection, or can enable him to enter a custom written explanation of his own.

If the inspector approves a claim, the system passes the inspector's decision to a payment transfer process for transferring the payoff to the user.

Example Scenario

In this specification, we will use a single scenario to make the methods disclosed clear.

For this scenario, we assume that an EVSPV is implemented within an online database that is a “service bureau” for more than one payer.

Second, we assume a payer, called BestSitter, that provides babysitting services, and that uses the EVSPV to make and transact payment offers.

Third, we assume that BestSitter has established a user account, including bank account.

Fourth, we assume the BestSitter posts three different kinds of payment offers: an offer to pay qualified prospects to view BestSitter's website, an offer to give a discount to qualified lower-income families, and an offer to pay people who refer in customers.

We note that the invention is not limited to this scenario or to the types of payment offers described in this scenario.

Initial Definitions

EVMPV. See above.

EVSPV. See above.

Payer. A person or organization (or an agent) offering an EV payment using the EVSPV. For convenience, also referred to as Paula.

Payer Bank Account. An account, maintained in the system, in which a payer deposits money (or a virtual account for keeping track of what the payer owes).

Payment Offer. An offer to pay a person or organization that meets/fits specified conditions a specified amount of money or a specified percentage of a sale (a sale is meant broadly to encompass any money or commodity transaction).

Recipient. A person or organization (or an agent) submitting a claim for payment. Also called a claimant. For convenience, also referred to as Reece.

System Bank Account. An account, maintained in the system for the system's money, to receive payment from payers and give payment to recipients (and possibly to send money to another system account for keeping system revenues).

Claim. A claim submitted for an EV payment corresponding to an EV payment offer.

Payoff claim. A claim submitted for a payoff from a winning EV payment claim.

Inspector. A system-authorized user who (1) decides whether a payoff claim is valid and (2) provides the inspection decision to the EVSPV.

### Part 1

### Payer Takes All the Payoff Risk

How the EVSPV enables payoffs to be transferred from payers to recipients depends on who takes the payoff risk. In this Part 1, we assume that the payer takes all the payoff risk.

If the payer assumes the all payoff risk that means that the payer has to pay the full payoff if a claim “wins” the payment bet that the EVSPV executes.

In this case, the system does not necessarily have to collect payment; it can be an accounting machine in the sense that it registers payment obligations but does not transfer actual payment. Thus, the system can include steps for notifying payers of their payment obligations and for notifying winning, qualified claimants that they are owed a payoff amount from a given payer.

For example, assume BestSitter is offering $10 EV to referrers, and assume that Ray, a referrer, wins $1,000 in the payment bet based on this offer, and assume that Ray meets the conditions of the offer. Then, EVSPV will notify Ray that BestSitter owes him $1,000 and will notify BestSitter that it owes Ray $1,000.

Alternatively, EVSPV can include a process for transferring payoffs from payers to winning, qualified claimants. This process includes steps for:
establishing a bank account for a payer,
receiving funds into in this account and,
transferring a payoff from the payer's account to a qualified claimant who has a winning, inspected, valid claim.
   Using a Two-Bet (“Parlay”) Process

Instead of using a single bet, an EVMPV and EVSPV can use a two-(or more)-bet process.

Accordingly, the invention provides a method for operating an EVSPV including the steps of:
execute a first bet in which Reece's payment claim has a given, first EV=x, and a First Payoff=y,
if Reece's claim loses this first bet, then set the claim value to zero, and do not continue executing bets for the claim,
if Reece's claim wins this first bet, then execute a second bet in which Reece's claim has an EV=y, and a Second Payoff=z,
   if Reece's claim loses this second bet, then set the claim value to zero, store the result, and do not continue executing bets for the claim,
   if Reece's claim wins this second bet, credit Reece's claim with provisional value=z.

One advantage of a parlay bet is that an initial bet payoff may not be enough to justify doing an inspection, but may justify inducing a claimant to supply payoff claim information, which can be used to set the terms of a second bet that has a higher EV and payoff than in the first bet (see Part 5 for an example case).

Another advantage of a two-bet process is that an EV payment claimant can be informed if he has won the first stage bet, and can be queried as to whether he meets the terms of the payment offers. The claimant's response can then be registered in a claims database and a user database.

For example, assume BestSitters offers Reece $1EV if he calls BestSitters, and if he buys babysitting services within 2 weeks of making the call. And assume that Reece calls BestSitters, using an EVSPV that registers Reece's claim to the $1EV.

Further, assume that this EVSPV executes a first bet in which Reece's claim has a payoff of $100 and a probability winning of 0.01. Further, assume Reece's claim wins this first bet.

Then, the EVSPV can query Reece and ask him if he indeed did buy babysitting services within two weeks of making his call to BestSitters. Reece can ignore the query, and the EVSPV can register this lack of response or, Reece can respond, “yes,” or “no,” and the EVSPV can register these responses as well.

If Reece responds, “yes,” then the EVSPV can execute a second bet. In this second bet, Reece's claim will have an EV=$100. Assume that the payoff is $500 and the probability of winning is 0.2. Finally, assume that Reece's claim wins this second bet, then the claim is provisionally worth $500, until an inspection takes place to see if Reece has met the conditions of the offer, that is, to see if Reece actually did buy babysitting services within two weeks of the call.

By querying recipients whose claims have won a first-stage bet, the EVSPS can gather and store data in a claims database and a user database (these databases can be a single database) so that a recipient's claiming history can be analyzed, particularly to find a pattern of cheating.

Accordingly, the invention provides a method for operating an EVSPV including the steps of:
query a claimant upon a claim winning a first payment bet,
ask the claimant whether the claimant has met the conditions of the EV payment offer,
store claimant's response or lack of response, in a claims database and/or a user database.

### Part 2

### System Takes All the Payoff Risk in Which EV is Deducted Per Bet from Payer

In this Part 2, we assume that the EVSPV takes all the payoff risk in payment bets.

If the EVSPV takes the payoff risk, it will include a system bank account and means discussed above for establishing a payer bank account.

We assume that a payer, Paula, has established a payer bank account.

Then, each time a recipient submits a claim corresponding to Paula's payment offer, the EVSPV will deduct the amount of money specified by Paula's offer from Paula's bank account (for instance, a debit account) and transfer it into an EVSPV account. From that EVSPV account the system will pay payoffs to recipients.

But the process is more complicated than that; it is different from a conventional payment transfer system. The problem is that Paula is offering EV payment only to qualified claimants, but claimants who accept her offer will include qualified claimants and non-qualified claimants.

Assume that Paula offers $1 EV. Now, assume that 2,000 claimants accept her offer.

How much does Paula owe the EVSPV? If she pays $1 per claim it is not fair because she is only supposed to pay for qualified claimants. She does not know and the EVSPV does not know what percentage of claimants is qualified.

Paula and the EVSPV cannot know if a claimant is qualified until the uncertainty is resolved when, and if, a claimant wins his payment bet and submits his payoff claim data for inspection.

Therefore, to compensate Paula for having money deducted from her account for invalid claims (submitted by non-qualified claimants), the EVMSP and EVSPV can include the step of refunding a payoff, provisionally won by a claimant, to Paula when:
1) a claimant does not submit a payoff claim on a winning claim (usually meaning that the claimant does not think that he is a qualified claimant)
2) a claimant does submit a payoff claim, but the corresponding inspection then reveals that the claimant is not qualified—i.e., that payoff claim is invalid.

For example, assume BestSitter is offering $1 EV to referrers. And, assume that Ray, the referrer, finds the offer, and selects the offer, thereby claiming the $1 EV. Then, the EVSPV would deduct $1 (definite dollar) from BestSitter's bank account and transfer it into an EVSPV account for paying off winning, valid claims. Assume that Ray's claim wins the payment bet with a payoff of $1,000. Then, assume that Ray does not submit a claim for the payoff. Then, the EVSPV would transfer to $1,000 to the BestSitter account. Likewise, if Ray does submit a claim for the payoff, but the claim is found invalid, then the EVSPV would transfer to $1,000 to the BestSitter account.

Accordingly, the invention provides a method for operating an EVSPV including the steps of:
register a claim by a Reece for a payment corresponding to Paula's EV payment offer,
deduct from Paula's account an amount of definite dollars equal to the EV of Paula's offer, and transfer that definite amount to an EVSPV account,
execute a payment bet to determine whether Reece's claim is a winner,
   if claim loses, set the value of the claim to zero,
   if the claim wins, ask Reece to submit a payoff claim,
      if Reece does not respond to the request, or if Reece responds that he cannot submit a payoff claim, transfer the payoff into Paula's account,
      if Reece submits a payoff claim, pass the claim to an inspector,
         if the inspector enters that the claim is invalid, then transfer the payoff into Paula's account,
         if the inspector enters that the claim is valid, then transfer (or authorize the transfer of) the payoff to Reece.
            (To compensate an inspector and encourage users to only submit valid payoff claims, the system can include a process for receiving an inspection fee from a payoff claimant, and/or an inspection deposit, to be forfeited if the claim is invalid.)
            The Problem with this Refund Method

The method of refunding payoffs to payers is fair in that, probabilistically speaking, on average, Paula gets back the money, deducted from her account, that pays for non-qualified claimants.

However, this “refunding” process is “lumpy” “lumpy” with infrequent, large payoff refunds that may not suit many payers, especially if the payoffs are too infrequent. For example, if Paula is offering $1 EV, and the payoff is $1,000, Paula may have over $1,000 deducted from her bank account to pay for non-qualified claimants, but she may not even receive a payoff refund. This situation will be unsatisfactory to many payers, especially payers that are very small businesses.

Below we give is one solution to this problem. In Parts 3 and 4 we describe two other solutions.

Using a Two-Bet (“Parlay”) Process

One solution is to split one payment bet into two, in which the payoff for the first bet is low enough so that a payer will receive refunds of a first payoff frequently enough to satisfy the payer (Paula). An EVMPV and EVSPV can use a two-bet process, as described in Part 1, with two key differences.

One difference is that the system takes the payoff risk in both payment bets. The EV amount is deducted, in definite money, from Paula's account, per claim submission (offer acceptance).

A second difference is that the first bet payoff is refunded to the payer if the claimant (Reece) does not respond to a query after winning the first-stage bet, or if Reece gives a negative response, saying, “I did not meet the conditions of the payment offer.”

If Reece gives a positive response, a second bet is executed. If Reece's claim wins this second stage bet, then the claim is provisionally worth the second payoff.

Paying this payoff is handled the same way that a payoff claim is handled above, in Part 2. That is, if an inspection reveals that Reece's claim is invalid, then the second stage payoff is refunded to the payer. If the inspection reveals that Reece's claim is valid, then the second stage payoff is paid to Reece.

Accordingly, the invention provides a method for operating an EVSPV including the steps of:
register a claim by Reece corresponding to an EV payment offer by Paula,
transfer from Paula's bank account to an EVSPV account an amount of money (x) equal to the EV offered in by Paula's offer,
execute a first bet in which Reece's payment claim has a first EV=x, and a First Payoff=y,
if Reece's claim loses this first bet, set Reece's claim value=zero, and do not continue making payment bets for the claim,
if Reece's claim wins this first bet, query Reece to see if he says he has met the conditions of the payment offer,
if Reece does not respond, or if Reece responds, “no,” then transfer (“refund”) the First Payoff, y, to Paula's account,
if Reece responds, “yes,” then execute a second bet in which Reece's claim has an EV=y, and a payoff=z,
   if Reece's claim loses this second bet, set Reece's claim value=zero, and do not continue making payment bets for the claim,
   if Reece's claim wins this second bet, assign Reece's claim provisional value=z
   ask Reece to submit payoff claim data,
      if Reece does not respond or if he says he cannot submit payoff claim data, then transfer (“refund”) the Second Payoff, z, to Paula's account,
      if Reece does submit payoff claim data, then send the data to an inspector to do an inspection,
         if the inspector finds the claim invalid, register that the claim is invalid and transfer (“refund”) the Second Payoff, z, to Paula's account,
         if the inspector finds the claim valid, pay the Second Payoff, z, to Reece's account (or authorize payment to Reece).

### Part 3

### Two-Bet Process Where Payer and System Take Separate Payoff Risk in Which the First Bet Payoff is Deducted from Payer

Part 1 described a two-bet process in which the payer takes the payoff risk in both bets. Part 2 described a two-bet process in which the system takes the payoff risk in both bets.

This Part 3 describes a two-bet process in which the payer takes the payoff risk in the first bet, and the system takes the payoff risk in the second bet.

This particular two-bet method can be useful because many payers cannot risk losing a large payoff, while virtually all payers can risk losing a payoff under a given threshold.

We note that the EVMPV can include steps for enabling a payer to set this threshold, or the threshold can be set by default. This threshold—a static amount or a multiple of a sale amount—can then be used as the payoff for the first bet in a two-bet process.

(As in Parts 1 and 2, we will often call a payer by the name, Paula, and an EV payment recipient/claimant by the name, Reece.)

Accordingly, the invention provides a method for operating an EVSPV including the steps of:
register a claim by Reece corresponding to an EV payment offer by Paula with EV=x,
execute a first bet in which Reece's claim has an EV=x, and a First Payoff=y,
if Reece's claim loses this first bet, set Reece's claim value=zero, and do not continue making payment bets for the claim,
if Reece's claim wins this first bet, then query Reece to see if he says he has met the conditions of the payment offer,
   if Reece does not respond, or if Reece responds, “no,” set claim value=zero,
   if Reece responds, “yes,” transfer y from Paula's account to an EVSPV account,
      execute a second bet in which Reece's claim has EV=y, and Second Payoff=z,
      if Reece's claim loses this second bet, the claim has zero value,
      if Reece's claim wins this second bet, the claim has provisional value=z,
         ask Reece to submit payoff claim data,
         if Reece does not respond or if he says he cannot submit payoff claim data, then transfer (“refund”) the Second Payoff, z, from the EVSPV account to Paula's account,
         if Reece does submit payoff claim data, then send the data to an inspector to do an inspection,
         if the inspector finds the claim invalid, register that the claim is invalid, and transfer (“refund”) the Second Payoff, z, from the EVSPV account to Paula's account,
         if the inspector finds the claim valid, pay Reece the Second Payoff, z, from the EVSPV account.

Importantly, we note that the process above does not have to include steps for informing Reece that his claim has won the first bet; the two-bet aspect can be hidden from him. In this implementation, Reece would not be queried, of course, after the first bet. The First Payoff would be transferred from Paula's account to an EVSPV account, as above. But, in order for Reece to be queried, Reece's claim would have to win both bets. If Reece did not respond to this query, or he if he did respond, and his claim was found invalid, then the EVSPV would transfer the payoff to the Paula's account.

Illustration

As an illustration of the process above, assume that BestSitters sets up an account with the EVSPV and deposits $200.

Assume that BestSitters makes an offer to pay $1 EV to anyone who refers in a customer.

Assume that Ray accepts this offer, that is, submits a claim.

Then the EVSPV registers the claim and executes a first bet with EV=$1 and, let us assume, a First Payoff=$50.

Assume that Ray's claim wins the bet.

Then, the EVSPV deducts $50 from BestSitter's account and transfers it to an EVSPV account for paying payoffs.

Then, the EVSPV informs Ray that his claim has won the first bet and asks Ray whether he has met the conditions of the corresponding payment offer.

If Ray does not respond, or responds negatively, then the EVSPV refunds the $50 to the BestSitter account.

If Ray responds positively, then a second bet is executed, with an EV=$50 and a Second Payoff=$1,000, let us assume.

Then, if Ray wins this bet, the EVSPV asks him to provide proof that he referred in a customer.

If Ray does not respond, or does not provide adequate proof, the EVSPV transfers the $1,000 to the BestSitter account.

If Ray does respond and provides adequate proof of his referral, then the system authorizes the payment of (or simply pays) the $1,000 to Ray.

### Part 4

### System Takes All the Payoff Risk and Uses a Discount Formula to Adjust for Invalid Claims

One way for the EVSPV to transfer payment from payers to recipients is to take all the risk in the payment bets, but to eliminate the refunding steps described in Part 2, and instead use a discount formula that generates a discount factor of some sort.

In Part 2, we described a method in which each time a recipient submits a claims corresponding to Paula's EV payment offer, the EVSPV will deduct definite money in the EV amount of the offer from Paula's bank account and transfer it into a EVSPV account. From that EVSPV account the system will pay valid, winning claims.

To repeat from Part 2, the process is more complicated than that; it is different from a conventional payment transfer system. The problem is that Paula is offering EV payments only to qualified claimants, but people who accept her offer—submit claims, that is—will include qualified claimants and non-qualified claimants.

To repeat, Paula and the EVSPV cannot know if a claimant is qualified until the uncertainty is resolved by the claimant winning his payment bet and then passing/failing an inspection.

To compensate/adjust for non-qualified claimants, the EVSPV can include a process for applying a discount factor to the EV payment amount that Paula offers to claimants.

Then, each time a user submits a claims for an EV payment under Paula's offer, Paula would not owe EVSPV the full amount of the EV stated in the offer, but a discounted rate. For example, if the EV amount offered to qualified claimants is $1 and the discount factor is 20%, then EVSPV registers that Paula owes 20 definite cents per submitted claim.

The goal in a discount factor is to represent the percentage of claimants who are qualified claimants. To arrive at a fair discount factor, the general idea is to gather statistics on what percentage of claimants are qualified.

These statistics can be gathered from the responses to offers within EVSPV that are similar to Paula's offer. The EVSPV can feed this response data into the discount formula(s).

Other methods, such as survey methods can be used as well to yield discount factor data to be fed into discount formulas as well.

The discount formula(s) will use data on how many winning claims are qualified claims.

EVSPV may include one or more formulas to determine the discount factor to be applied to a payer's offer.

Accordingly, the invention provides a method of operating an EVSPV such that the EVSPV takes the payoff risk in EV payment bets and further includes:
a discount formula process (or processes) for arriving at a discount factor, to be applied to the EV amount of a payment offer.
   (Alternatively, in certain implementations, the EVSPV will not include a discount formula, but will include means for enabling a system administrator to enter a discount factor.)

Further, when a user submits a claim for EV payment, the EVSPV will:
apply the appropriate discount factor to the EV payment amount,
deduct the resulting amount from the payer's bank account,
transfer the amount to a EVSPV account that is used to pay winning, qualified claimants.

Further, in the inspection process, when an the inspector approves a claim, the EVSPV will:
register that the claimant is owed the payoff from the EVSPV account that is used to pay winning claimants.

Note that while the amount being deducted from Paula's account is (EV)×(Discount Factor), or EV adjusted in some way by a discount formula, the EV of the payment claim remains the EV that was offered by Paula.

Thus, one weakness of the process above is that Paula and Reece can cheat by acting in cahoots. Because of the discount factor, the amount that Paula has to pay is not the full EV, while the system executes a bet where Reece does receive the full EV. The system makes up the difference. So, if Paula and Reece are cheating, they will receive, on average, (EV)−(EV×Discount Factor).

### Using a Two-Bet Process Where Payer and System Take Separate Payoff Risk in Which the First Bet Payoff, Adjusted by a Discount Factor, Is Deducted from the Payer's Account

The EVSPV can enable Paula to take the payoff risk in the first bet, but can apply a discount factor to this First Payoff. Thus, if the claimant wins this first bet, the system can deduct the First Payoff of this first bet, adjusted by the discount factor described above, from Paula's bank account and transfer this discounted First Payoff to the EVSPV account.

The EVSPV can then take the payoff risk in the second bet.

As with the process above, although a discount factor is applied to Paula's payoff obligation, the EV of the claim in this second bet equals the full First Payoff (the payoff of the first bet).

If the claim wins both bets, and if an inspection finds the claim valid, then the EVSPV transfers the second bet payoff to Reece.

### Part 5

### Two-Bet Processes in Which EV Payment Equals a Percentage of a Sale

Context: Payment Offers Where the EV Payment Depends on an Uncertain Event, Especially a Purchase Amount (an Amount of Money in a Transaction)

In many kinds of EV payment offers, the amount of EV payment will depend on an uncertain event or series of events, such as the amount of a sale.

In particular, the amount of EV payment can be a percentage of the amount of money involved in an economic transaction, which we will call a sale amount, where sale is a generic term that encompasses any kind of sale, lease, loan, donation—and amount encompasses any amount of money transferred in an economic transaction.

For instance, BestSitters might offer Reece a payment for attention where the EV payment is 1% of how much Reece spends on babysitting services over the next month. In this case, the sale amount, and hence the specific EV payment amount, will not be known until the month has passed.

The EVMPV and EVSPV can include steps for handling payments that are contingent upon uncertain events, in particular, payments that are a percentage of sale amounts.

The steps involved are straightforward if one payment bet is used. In this case, the claimant will provide the sale amount information during the inspection process.

For instance, if BestSitters offers 1% of a sale amount to Reece, then a bet is executed. Let us assume that the probability of Reece's claim winning is 1/1000. Then, if Reece's claims wins, it will be worth 1%×1,000=10,000%=10 times the sale amount.

If Reece's claim wins, the EVSPV will ask Reece if he bought babysitting services over the past month, and if so, how much did he spend?

Let us assume Reece spent $80, then he will be owed $800.

So, to handle percentages, a payoff multiple is used in the EV payment bet.

Two-Bet Processes Where Uncertainty is Resolved (Sale Amount Information is Provided) After the First Bet

If a two-bet process is used, then the first bet can use a payoff multiple.

Let us assume that the process of Part 3 is used in which Paula takes the payoff risk in the first bet and the EVSPV takes the payoff risk in the second bet.

The invention provides a method for operating an EVSPV including the steps described below.

If Reece's claim wins the first bet, the EVSPV can ask Reece if a sale was made, and if so, how much was spent. Reece can supply the answer, and the second bet terms can be based upon this information.

For example, let us assume the payoff multiple in the first bet is 10×, so that the probability of a claim winning is 1/10. Then, if Reece's claim wins this first bet, the claim is provisionally worth 10× the EV payment percentage offered.

Then, the EVSPV asks Reece if a sale was made, and if so, how much was spent. If Reece responds and supplies the sale amount, then this sale amount can be multiplied by the payoff multiple and multiplied by the EV payment percentage to arrive at a First Payoff that can be deducted from Paula's account.

For instance, assume the EV payment percentage offered is 1%. Assume the payoff multiple is 10×. And, assume that Reece says that a $600 sale was made. Then, (1%)×10×$600=$60. This $60 is transferred from Paula's account to the EVSPV account for paying payoffs. And, this $60 is the EV of the second bet.

Two-Bet Process Where the Uncertainty is Resolved (Sale Amount Information is Provided) After the Second Bet

It is also possible NOT to tell Reece that his claim has won the first bet, but simply to deduct some amount of definite money from Paula's account to be transferred into an EVSPV account, that is then used by pay out payoffs.

But, if the sale amount is not known, how much definite money is to be deducted from Paula's account?

One solution is for the EVSPV to check Paula's payment offer and assume the worst-case scenario, that Reece will report that largest sale possible under Paula's offer. The EVSPV, in other words, can deduct the maximum amount from Paula's account.

This method raises the problem of overpayment. To solve this problem, the refunding approach of the processes of Part 2 and Part 3 can be used.

When the uncertainty of the sale amount is resolved, the excess payment in definite dollars can be refunded, but refunded multiplied by the payoff multiple.

For example, assume that the payoff multiple of the first bet is 10×, and assume that the payment offer is 1% of a sale amount. Then, Reece is owed 10% of the sale amount.

Assume that the maximum sale amount under Paula's offer is $1,500, then Reece could potentially be owed $150. The EVSPV can deduct this amount from Paula's account.

Then, let us assume that the payoff multiple of the second bet is 10× as well. Then, if Reece's claim wins this bet, the claim is provisionally worth $1,500.

Now, let us assume that Reece submits a payoff claim stating that he spent $90.

Then, Reece would be owed $90 as the second payoff, NOT $1,500.

But, if the uncertainty had been resolved after the first bet, then Paula should only have paid $9, which is 10%×$90. Instead, Paula had $150 deducted from her account. So, she is owed $141. But, it is actually $141×10×−$1410.

Because of the complexity of this approach, it seems that, in practice, the uncertainty will be resolved after a claim wins a first bet, as described above.

### Part 6

### Using Deposits to Reduce Inspection Costs

Inspecting a Fraction of the Payoff Claims

We expect that in most implementations of the invention, a claimant would have to put up a deposit or pay an inspection fee, both of which can ensure that his claim was valid.

The inspection fee would be paid whether the claim was valid or not. The deposit would be forfeit if the claim were invalid.

A twist on the idea of a deposit, to increase the efficiency of inspection, is to ask claimants to put up a large deposit (to post a bond, so to speak), and only inspect a fraction of the claims, with some pre-set selection method (e.g., random selection of claims).

The un-inspected claims would be presumed valid. The inspected claims, if invalid, would cause the deposit to be confiscated.

Accordingly, the invention provides a method of operating an EVSPV including the steps of:
executing an EV payment bet for a claim,
if the claim is loses, set the value=0,
if the claim wins, ask claimant to submit deposit of money to guarantee that the claim is valid,
   if the claimant does not submit the deposit, set the value of the claim=zero,
   if the claimant submits the deposit, store the deposit in an escrow-type account such that the deposit corresponds to the winning claim,
      subject the claim to a pseudo-random chance of being inspected according to a pre-set selection formula,
      if a winning claim has not been selected for inspection, assume that the claimant meets the conditions of the EV payment offer, pay the winning claimant the payoff, and release the deposit from the escrow account back to the claimant,
      if a winning claim has been selected for inspection, request payoff claim data (inspection data) from the claimant,
         if the claimant does not provide the payoff claim data, set the value of the claim=0, and confiscate the claimant's deposit,
         if the claimant provides payoff claim data, inform an inspector that the claim needs inspecting,
         if the inspector enters a decision that the claim is invalid, set the claim value=0, and confiscate the claimant's deposit,
         if the inspector enters a decision that the claim is valid, set the value of the claim=to the payoff of the payment bet, and authorize payment of the payoff to the claimant, and release the deposit from the escrow account back to the claimant.
            Centering the Invention Around the Use of Deposit (Around the Posting of Bonds)

The EVMPV and EVSPV use expected payments to reduce the number of inspections of claims.

It is possible to reduce inspections solely by using the method of having claimants post a bond to vouch for the honesty of their claims, and then auditing a percentage of those claimants.

We do not feel that this will be the dominant approach in the market because it requires people to put up large deposits upfront, but we note the possibility.

Instead, by reducing the average cost of inspections, the use of deposits may be an important addition to the payment processes of an EVMPV and EVSPV.

Further, and as a separate, useful process, the EVMPV and EVSPV can include steps that enable a claimant to choose whether to be paid:
1) an EV payment or
2) a definite payment contingent upon the claimant putting up a deposit and having the claim subject to inspection, according to a mostly/somewhat random selection.

This approach can work well when an EVSPV enables EV payments that range from small, say, 10 EV cents, to large, say 300 EV dollars. In some cases, claimants will prefer to receive definite payment rather than EV payment.

### Part 7

### Miscellaneous Sub-Methods for Efficient and User-Friendly Transactions

Periodic EV Payments

In certain cases, an EV payment offer may stipulate that Reece will be paid periodically, such that he must meet the conditions of the payment offer during each, defined period. For example, Paula may offer to pay Reece a 5% EV referral fee for each month that a customer buys from Paula. Each month, then, Paula can check whether the customer has remained a customer. When the customer drops away, then Reece is no longer owed the EV referral fee.

The EVMPV and EVSPV can accommodate periodic payments by treating each period as a separate payment that requires a separate claim to be made. Or the EVMPV and EVSPV can enable a singe claim to trigger a series of payment bets, per period, that continue until a claimant requests that they stop. Or, the EVMPV and EVSPV can assume that the first period payment will determine the total payment. The possibilities are various and will depend upon the implementation and the payment offer.

Allowing Recipients to Assign EV Payments

One problem with the EVMPV and EVSPV is that many claimants do not like EV payment and would prefer definite payment. A way to solve this problem is for a claimant, before the result of his EV bet is revealed, to assign his EV bet payoff to a third party. The third party could pay the claimant a percentage of the EV for this assignment, through a private transaction, thus enabling the claimant to receive definite payment instead of EV payment. The third party would then collect the payoff, if any, upon a successful inspection.

Alternatively, the EVSPV can facilitate and record assignments. Further, the EVSPV could list EV payments to a recipient so that a recipient can assign a set of EV payments to a third party.

Accordingly, the invention can provide a method for operating an EVSPV including the steps of:
enabling a user to designate an assignee for one or more of the EV payments he claims,
enabling a user to state which EV's he is genuinely eligible for—i.e., claims in which he has met the conditions of the EV payment offers,
listing and tallying all the claims for EV payment a user has stated he is genuinely eligible to receive,
designating an assignee for the set of claims for EV payment a user has stated he is genuinely eligible to receive.
   Showing Net EV's

The owners of an EVSPV will usually need to be paid for its operation. As discussed, there are various ways of charging users for the services of the EVSPV. Some of these ways will involve transaction fees. These fees can be reflected in the EV's, odds, and payoffs of payment bets. That is, the EVSPV can show net EV's to claimants/recipients that are different from the EV's advertised by payers in their payment offers.

Meta-Directory for Collecting and Sorting Similar EV Payment Offers

An EVSPV that transacts a particular kind of payment offer, such as a system for targeted discount offers, or referral offers, or payment-for-attention offers, will probably not be a monopoly service. There will be more than one EVSPV doing essentially the same thing.

Given this reality, it will be useful for payers and recipients of payment to collect all similar offers and put them in one sorted list. In other words, it will be useful to create a meta-directory of offers that are posted in EVSPV's.

This kind of meta-directory can be created through a central service that handles queries from payment claimants and then pulls matching offers from various EVSPV's and sorts those offers.

Or, the meta-directory can be created via software on a user's personal machine, such that the software takes a user query for a payment offer and then pulls matching offers from various EVSPV's, and sorts those offers, and presents a sorted list of those offers.

A meta-directory is obviously helpful to payment claimants. But it is also helpful to payers, especially a central service embodiment, because it can help collect global statistics that can be used to deter cheating and make payment offers more efficient.

1. I claim:
a method for operating an online computer database system for transacting expected value (EV) payment offers, that is, offers in which a payer specify the amount of EV payment to be paid to a qualified recipient; said method comprising the steps of:
enabling a recipient to accept the offer,
after said recipient accepts said offer, splitting the EV payment process into two-bet parlay process such that the EV of the first bet equals the EV payment set by said payer, and the EV of the second bet equals the payoff from the first bet,
said payer taking the risk of losing the payoff in the first bet, and said system taking the risk of losing the payoff in the second bet,
if said recipient wins said first bet, the system registering that the payer owes the payoff of this first bet to the system, and said system asking said recipient whether he meets the conditions of said payment offer,
if the response is negative, the system refunding the payoff to the payer,
if the response is positive, the system executes said second bet,
if said recipient wins said second bet, said recipient provisionally has won the second bet payoff (larger than the first bet payoff),
said system then enabling said recipient to request an inspection by a system-authorized inspector,
if the inspection reveals that recipient has met the conditions of the offer, the system pays him the second bet payoff,
else, if said recipient has not met the conditions, or if said recipient does not request an inspection, said system refunds the second bet payoff to said payer.
